(19) United States
(12) Patent Application Publication
(10) Pub. No.: US 2012/0030097 A1
(43) Pub. Date: Feb. 2, 2012

(54) Apparatus and Method for Valuing Articles

(76) Inventors: Christopher John Hagan, Bergen (NO); Mark Ian Shipley, Wirral (GB)

(21) Appl. No.: 13/263,239

(22) PCT Filed: Apr. 6, 2010
(86) PCT No.: PCT/GB10/50589

§ 371 Date: Oct. 6, 2011

(30) Foreign Application Priority Data
Apr. 8, 2009 (GB) 0906273.8

(51) Int. Cl. G06Q 20/00; G06Q 30/00

(52) U.S. Cl. 705/39; 705/306

(57) ABSTRACT

Embodiments of the present invention provide apparatus for automatic valuation of articles. The apparatus may comprise an article receiving device arranged to receive an article therein; and an article assessment device arranged to determine the presence of a prescribed one or more materials in said article along with the quantity thereof, the article assessment device being arranged to determine a value of the one or more materials present in the article based on a stored amount of the value of a given quantity of each of said one or more materials, and the quantity of the one or more materials present in the article as determined by the article assessment device, and to output to the user the value of said article based on the value of the one or more materials and/or output to the user the value of the one or more materials.

### FIELD OF THE INVENTION

The present invention relates to apparatus and a method for valuing articles presented to the apparatus.

### BACKGROUND

It is known to provide apparatus capable of dispensing automatically a number of different items, some items being of value and others having no particular face value. Such apparatus may be provided in both public and private secure places.

For example, cash dispensing machines, automatic booking machines and payment machines are well known. In the case of cash dispensing machines the importance of ensuring personal safety and the physical security of the dispenser have been addressed, different arrangements having been proposed to ensure that these problems are overcome.

For example, a dispensing machine may be provided in a secure area which can only be accessed by entry of a suitable code either manually or via a machine readable card.

It is an object of some embodiments of the present invention to provide a system in which articles containing precious materials can be valued automatically by a machine provided in a public area and which can issue monies in the form of cash or credit vouchers, or credit in any other form, to an amount dependent upon the valuation of the article.

### STATEMENT OF THE INVENTION

In a first aspect of the invention there is provided apparatus for automatic valuation of articles comprising: an article receiving device arranged to receive an article therein; and an article assessment device arranged to determine the presence of a prescribed one or more materials in said article along with the quantity thereof, the article assessment device being arranged to determine a value of the one or more materials present in the article based on a stored amount of the value of a given quantity of each of said one or more materials, and the quantity of the one or more materials present in the article as determined by the article assessment device, and to output to the user the value of said article based on the value of the one or more materials and/or output to the user the value of the one or more materials.

It is to be understood that with such apparatus it is possible to allow a user to obtain an automatic valuation of any article which may contain materials having a monetary value, for example an article containing precious materials, for example jewellery, circuit boards, mobile phones and, if they so desire they can accept monetary valuation made by the system and can in some embodiments instantly obtain cash or other credit vouchers to the value of the valuation.

The apparatus may comprise or be coupled to a computing device running a back-end software solution arranged to determine the value of the one or more materials. The computing device may be further arranged to determine the value of the article based on the value of the one or more materials.

Preferably the apparatus is operable by a user to do one selected from amongst provide payment to the user in return for the article and to return the article to the user.

Preferably the apparatus comprises a dispenser by means of which, if payment is requested by the user, monies or other credit voucher can be issued to the user.

The apparatus may be arranged to provide a credit to a bank account or credit card account in the event a user requests payment.

Preferably the apparatus is arranged to perform a tomographic energy dispersive diffraction imaging (TEDDI) analysis of the article thereby to determine the amount of a given material in the article.

This has the advantage that a 3D spatial distribution of different materials in the article may be determined.

The apparatus may be arranged to determine a type of an article presented to the apparatus.

The apparatus may be arranged to determine a type of the article based on one selected from amongst an input from a user, an output from the article assessment device and an output from an image capture device.

Thus, recognition of an article may be automatic in some embodiments, for example using an image capture device such as a video camera or data from the article assessment device, such as TEDDI data, and object recognition software.

Preferably the apparatus is arranged to adjust a value of the article or of the one or more materials present in the article based on a cost of extraction of the one or more materials from the article based on the type of article presented.

This has the advantage that a more fair price may be determined for which the operator is willing to buy an article.

The apparatus may be arranged to offer a data recovery service to a user in the event an article having recoverable data therein is presented to the apparatus.

Preferably the apparatus is arranged to tag an article presented to the apparatus thereby to enable identification of the article as a previously presented article if the article is subsequently presented again to the apparatus.

Preferably the apparatus is arranged to tag the article after a user consents to the article being retained by the apparatus.

This has the advantage that if for example an article is stolen from a storage portion of the apparatus the apparatus is able to recognise that payment has already been made for the article.

More preferably, the apparatus is arranged to tag the article by application to the article of a quantity of a substance recognisable by the apparatus.

The substance preferably comprises a liquid, the apparatus being arranged to apply the liquid to the article by spraying.

Preferably the apparatus is arranged to convey an article from the article assessment device to a storage portion of the apparatus.

Preferably the apparatus is arranged to determine the quantity in an article of at least one material selected from amongst a precious metal, a semi-precious metal, a metallic material and a plastics material.

Preferably the apparatus is arranged to obtain updated market values of the one or more materials in real time.

Thus the apparatus may be coupled to a data network to obtain updated market values of different materials, enabling an equitable price to be agreed for an article.

In a second aspect of the invention there is provided a method of valuing an article comprising: receiving by means of a receiving device an article to be valued; determining by means of an article assessment device the presence of a prescribed one or more materials in said article along with the quantity thereof; determining a value of the one or more materials present in the article based on a stored amount of the value of a given quantity of each of said one or more materials; and outputting the value of said article based on the value of the one or more materials and/or outputting the value of the one or more materials.

The method may comprise the step of offering a user payment in exchange for the article.

Preferably, the method comprises the step of returning the article to the user if the user rejects the offer of payment.

The method preferably comprises the step of storing the article in the apparatus if the user accepts the offer of payment.

Preferably the method comprises the step of dispensing payment to the user by means of a dispenser.

Optionally, the method may comprise the step of issuing credit to a user electronically.

Preferably the article assessment device is arranged to perform a tomographic energy dispersive diffraction imaging analysis of the article thereby to determine the amount of a given material in the article.

The method may comprise the step of identifying a type of the article.

The step of identifying the type of the article may comprise at least one step selected from amongst the steps of requesting a user to input an indication of the identity of the article, processing of data obtained by means of the article assessment device, thereby to identify the article and processing data obtained by means of an image capture device thereby to identify the article.

The method preferably comprises the step of adjusting a value of the article based on a cost of extraction of the one or more materials from the article.

Preferably the method comprises the step of offering a data recovery service to a user in the event an article potentially having recoverable data therein is presented to the apparatus, the method further comprising recovering data from the article and providing it to the user if the user requests the service.

Preferably the method comprises the step of tagging an article introduced into the apparatus thereby to enable identification of the article as a previously introduced article if the article is subsequently reintroduced into the apparatus.

The method may comprise the step of tagging the article after a user consents to the article being retained by the apparatus.

The method may comprise the step of tagging the article by application to the article of a substance recognisable by the apparatus.

The substance may comprise a liquid and the method may comprise the step of applying the liquid to the article by spraying.

The method may further comprise the step of determining the quantity of at least one selected from amongst a precious metal, a semi-precious metal, a metallic material and a plastics material contained in the article by means of the article assessment device.

The method may comprise the step of updating the amount of the stored value of the given quantity of material based on a current market value of the material.

In a further aspect of the invention there is provided apparatus for automatic valuation of articles of precious materials comprising an article receiving device arranged to receive an article therein and to bring the said article to an article assessment device, said article assessment device being adapted to assess the presence of a precious material in said article along with the quantity thereof, said article assessment device being linked to a storage device which contains real time values of various precious materials whereby said article assessment device can provide a valuation of said article to a user, said system also including a user operable control with which a user can indicate acceptance or otherwise of the valuation provided, and dispensing means by means of which, if the valuation is accepted, monies or other credit voucher can be issued to a user.

In a further aspect of the invention there is provided a method of valuing an article comprising: presenting the article to an article receiving device arranged to receive an article therein; determining by means of an article assessment device the presence of a given material in said article along with the quantity thereof; determining a value of the material present in the article based on a stored value corresponding to the value of a given amount of said material; and outputting a valuation of said material.

In one aspect of the invention there is provided apparatus for automatic valuation of articles comprising: an article receiving device arranged to receive an article therein; and an article assessment device arranged to determine the presence of a prescribed one or more materials in said article along with the quantity thereof, the article assessment device being arranged to determine a value of the one or more materials present in the article based on a stored value of a given quantity of each of said one or more materials, the apparatus being arranged to output to the user the value of said article based on the value of the one or more materials and/or to output the value of the one or more materials.

In a further aspect of the invention there is provided apparatus for automatic valuation of articles comprising: an article receiving device arranged to receive an article therein; and an article assessment device arranged to determine the presence of a prescribed one or more materials in said article along with the quantity thereof, the article assessment device being arranged to determine a purchase price being a price a buyer is willing to pay for the article, the purchase price being based on a stored price of a given quantity of each of said one or more materials, and the quantity of the one or more materials present in the article as determined by the article assessment device.

### BRIEF DESCRIPTION OF THE DRAWINGS

Embodiments of the invention will now be described with reference to the accompanying figures in which:

FIG. 1 shows a system according to an embodiment of the invention;

FIG. 2 shows a sequence of screen shots of a display screen of the embodiment of FIG. 1 in use;

FIG. 3 shows (a) an x-ray image of a laptop computer obtained using apparatus according to an embodiment of the invention, (b) a compositional analysis of materials from which the computer is formed together with a valuation thereof, and (c) a flow diagram showing a process according to an embodiment of the invention by which the materials comprised in the laptop computer may be valued automatically;

FIG. 4 corresponds to FIG. 3 in respect of a toaster machine and shows (a) an x-ray image of the toaster machine obtained using apparatus according to an embodiment of the invention, (b) a compositional analysis of materials from which the machine is formed together with a valuation thereof, and (c) a flow diagram showing a process according to an embodiment of the invention by which the materials comprised in the machine may be valued automatically;

FIG. 5 is a schematic illustration of a method by which a user may obtain a valuation of an article, and exchange the article for monetary payment; and

FIG. 6 illustrates the detection of a fake article intended by a fraudster to be passed off as a solid gold ring.

### DETAILED DESCRIPTION

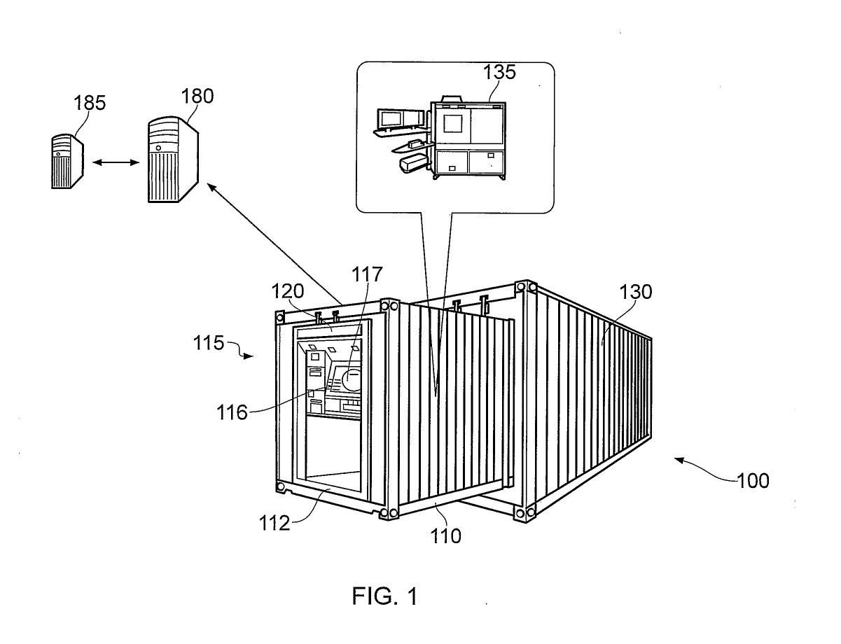

FIG. 1 shows valuation apparatus 100 according to an embodiment of the invention. The apparatus 100 has an article reception and analysis portion 110 and a storage container 130 for storing articles retained by the apparatus 100.

The article reception and analysis portion 110 has a user interface module (UIM) 115 arranged to communicate with the user. In the embodiment shown the UIM 115 is arranged to obtain information in respect of a user's identity and to invite the user to submit an article for valuation.

An article submission portion 112 is provided immediately below the UIM 115 into which the user may place an article to be valued.

Once an article has been received into the article submission portion 112, the article is conveyed to a scanning device 135 housed within the article reception and analysis portion 110. The scanning device 135 is arranged to scan the article and determine a quantity of precious material in the article. By precious material is meant a material having a monetary value when extracted from the article. For example, an article such as an electronic circuit board may contain copper, gold and other metals of value.

Other materials, such as plastics materials, although not commonly referred to as precious materials due to their relatively low value, may still have monetary value when extracted from the article. Thus, in some embodiments of the invention the apparatus 100 is arranged to determine the amount of plastics material and subsequently a value of the material.

Other materials may also be valued.

Some embodiments of the invention have the advantage that because a compositional analysis is performed, a type of plastics material present may be determined more precisely allowing a more precise valuation to be obtained. This may be of benefit to both the operator of the apparatus 100 and the user.

The valuation apparatus 100 has or is in communication with a server 180 arranged to administer an operation of the apparatus 100. For example, the server 180 may control the apparatus 100 to obtain information about a user in order to verify an identity of a user. For example, the apparatus 100 may be arranged to request a user to insert a credit or debit card into the machine, or to enter a bank account (or other account) number.

The apparatus 100 is thereby able to trace a user in case of a query in respect of any transaction carried out with the apparatus 100. For example, if an article submitted to the apparatus is later found to have been stolen, this information may be of value in investigating the theft.

The server 180 may be arranged to obtain real-time precious materials prices from a data source 185 such as a web-server or other data source 185, from which a suitable valuation of the article may be determined. Thus, in some embodiments the apparatus 100 determines a value of the article based on the amount of precious material in the article and the value of the precious material.

It is to be understood that instead of using values updated in real-time, the apparatus 100 may instead or in addition be arranged to use a fixed value, for example a daily, weekly or monthly value provided to the apparatus as required. Other arrangements are also useful.

After a value of the article has been determined based on the analysis performed by the scanning device 135 the UIM 115 is arranged subsequently to provide an output to the user of a price the operator of the apparatus 100 is prepared to pay for the article. If the user accepts the price, the apparatus 100 conveys the article to an article storage container 130 and dispenses payment to the user.

The price the operator is willing to pay may be a price that is less than the market value of the materials by an amount depending on a cost of recovering the materials and a required profit margin for the operator.

Payment may be in the form of a credit to a bank account or other account such as a credit card account. Alternatively or in addition payment may be in the form of a printed or electronic voucher or coupon, or in cash.

Other forms of payment are also useful in some embodiments.

It is to be understood that the scanning device 135 may take any suitable form as desired or appropriate. In a preferred embodiment the scanning device 135 scans the atomic or molecular structure of the article and detects the nature and quantity of any precious material in the article. In addition or instead, in some embodiments the apparatus 100 detects only a prescribed one or more materials as per an operator's requirements. For example, the apparatus may be arranged to determine only the amount of a given material such as gold metal, and to value that material only.

In the embodiment shown, the scanning device 135 has a tomographic energy dispersive diffraction imaging (TEDDI) system. The scanning device 135 is arranged to expose the article to an x-ray beam and to determine the amount of a given precious material present in the article based on an analysis of x-ray signals generated as the x-ray beam interacts with the article. The amount of a given material is obtained by performing a computed tomography (CT) scan.

In the embodiment shown in the figures the apparatus 100 takes the form of a standalone unit capable of dispensing cash in a similar manner to a conventional cash machine if a user accepts the valuation of the article submitted. The UIM 115 has a visual display screen 117 and push-buttons 116 adjacent the screen to allow a user to control the apparatus 100. Alternatively the apparatus 100 may have a keypad or touch-screen for user input.

It is to be understood that in some installations of apparatus according to embodiments of the invention it may be preferable to locate the apparatus in a secure area as in the case of some existing cash dispensing machines. For example, the apparatus 100 may be located behind one or more security screens beyond which access can only be gained using a suitable access code.

It may also be advisable to empty the apparatus 100 regularly in order to avoid the apparatus 100 becoming a target for criminals.

Embodiments of the invention may be operated as follows.

The apparatus 100 may be placed in a public place, adjacent to an area in which the public are present to assist with security. Thus the unit can be placed adjacent traditional cash dispensing machines in supermarkets or shopping centres.

In some embodiments, a user of the apparatus 100 (or ‘machine’) must first satisfactorily identify themselves to the apparatus 100 by way of presenting identification means such as a bank card, passport or driving license. The identification is read by the apparatus 100 and the details are stored in case of query over any transaction carried out.

The user is then able to insert into the article submission portion 112 an article to be valued. Suitable articles can include mobile phones, circuit boards, items of jewellery, watches or coins.

It is to be understood that substantially any valuable material in any suitable item can be identified and valued by the apparatus 100. Embodiments of the invention are directed to the determination of the amount of a material having an intrinsic value and capable of being valued automatically.

Using the scanning device 135 the apparatus 100 analyses the article placed in the article submission portion 112 and identifies the amount of a prescribed one or more materials contained in the item (such as precious, semi-precious and non-precious metals, plastics materials etc). Via the server 180 a real-time price for each material identified is obtained and a valuation of the article is displayed to the user on the display screen 117.

The user is then able either to accept or decline the valuation.

If the user declines the valuation, the article evaluated is returned to the user. If the valuation is accepted, the user can request that cash is dispensed to them. Alternatively the user can request that credit is made to an account such as a bank account or credit card account. Other forms of credit may be appropriate in some embodiments.

For example, the apparatus 100 may be arranged to offer a user a voucher towards an article of similar type. Thus the apparatus 100 may be operated in cooperation with a vendor or manufacturer so that a user submitting (say) a laptop computer is offered a discount on a new computer or similar article in return for the article. The operator of the apparatus 100 may thus be able to access revenue streams other than that associated with the products of recycling precious materials in submitted articles.

To prevent an item being presented more than once to the apparatus 100 to obtain cash or other credits, in some embodiments the article may be sprayed within the apparatus with a unique spray marking liquid which cannot be easily removed by a user. Thus, if an article is stolen from the storage container 130 and resubmitted to the apparatus 100, the apparatus 100 is able to detect the presence of the spray and take appropriate action.

It is to be understood that other arrangements are also useful.

It will be appreciated that with the arrangement of the present invention, users can conveniently obtain monies or credit for unwanted items which contain precious materials and this may be of considerable benefit to particular individuals.

It is to be understood that the apparatus 100 may be arranged to recognise articles submitted to the apparatus 100 based on data obtained by the scanning device 135. Thus, having identified a type of the article according to a suitable classification (e.g. ‘laptop computer’, ‘gold ring’ etc) the apparatus may be arranged in some embodiments to determine a value of the article taking into account particular factors associated with recycling the article to reclaim the precious materials.

Thus, in the case that a solid gold ring is presented, the apparatus may determine that the gold may be recycled relatively easily since no other materials are present.

In contrast, if a laptop computer is presented or a circuit board or mobile phone, the apparatus may be arranged to adjust a price the operator is willing to pay for the article in view of the expense associated with recycling the article. For example, any gold present in a laptop computer (being typically associated with connectors and integrated circuits, amongst other components) is typically in the form of thin coatings.

It is to be understood therefore that for a given weight of gold, the cost of extracting the gold from a computer will typically be much higher than that of extracting the gold from a solid gold ring. Accordingly, the apparatus may be arranged to offer a higher price per unit weight of gold in an item of jewellery, such as a solid gold ring, than in a computing device where the gold is more dispersed within the article and therefore more costly to extract.

Thus, it is to be understood that the employment of a scanning system 135 or any other suitable article assessment device capable of determining an actual or likely 3D spatial distribution of precious materials contained in an article is particularly advantageous in some embodiments.

The TEDDI technique has the advantage that data in respect of both a quantitative analysis of a composition of an article and a spatial distribution of material of a given composition within the article may be obtained, thereby facilitating the intelligent valuation of an article as described above.

In some embodiments the apparatus 100 is arranged to compare data obtained from a scan of an article with a database of data in respect of known articles. By comparing data obtained from an article with previously stored data, apparatus 100 according to some embodiments is capable of identifying the type of article submitted.

In some embodiments the apparatus 100 is arranged to verify with the user that the apparatus 100 has correctly identified the article. If the user considers the article has been incorrectly identified the apparatus 100 may be arranged to return the item to the user or to arrange a repeat or alternative analysis or inspection.

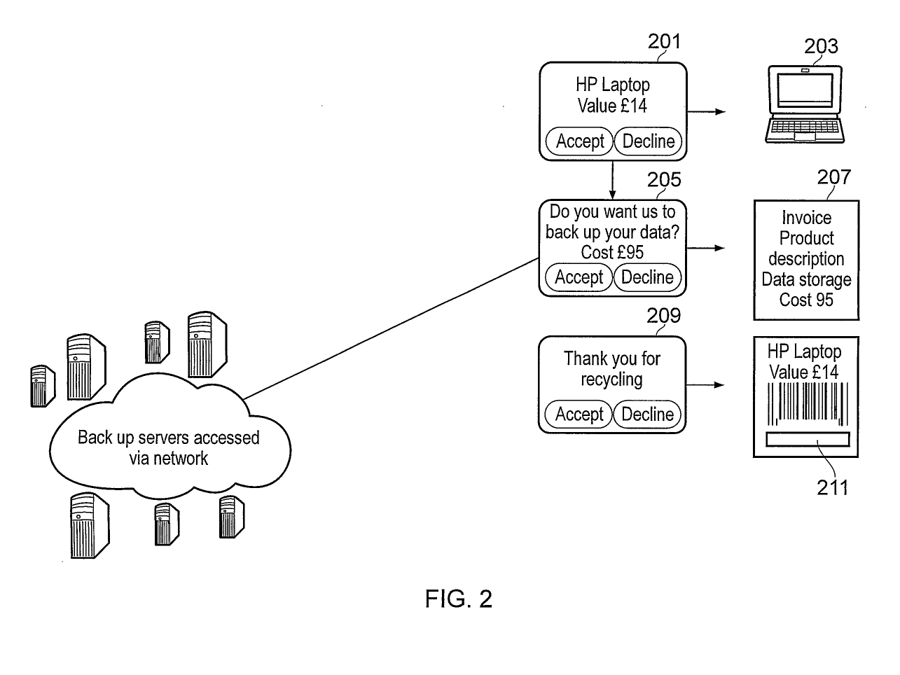

FIG. 2 shows a sequence of screenshots of the display screen 117 of the UIM 115 once an analysis and valuation of an article has been performed.

At step 201 the display screen provides the user with an indication of the identity of the article based on the analysis (in this example the article is a laptop computer) and the price the operator of the apparatus 100 is prepared to pay for the article.

The user is provided with the option to accept the offer or to decline the offer. If the user declines the offer, then at step 203 the article is returned to the user.

If the user accepts the offer, at step 205 the user is offered a backup service of data contained in the article. In some embodiments this service may be offered only when the apparatus determines that the article is one that may have recoverable data stored therein that may be of interest to the user. The user may accept or decline the offer, which may have a cost associated with it.

If the user accepts the offer, at step 207 the apparatus 100 issues an invoice to the user if appropriate (e.g. the cost of data recovery exceeds the value of the article) and the operator arranges for the user's data to be extracted and returned to the user. Alternatively or in addition the apparatus 100 may invite immediate payment if required.

If the user declines the offer to backup data, then at step 209 the apparatus thanks the user for recycling the article and at step 211 provides the user with appropriate payment.

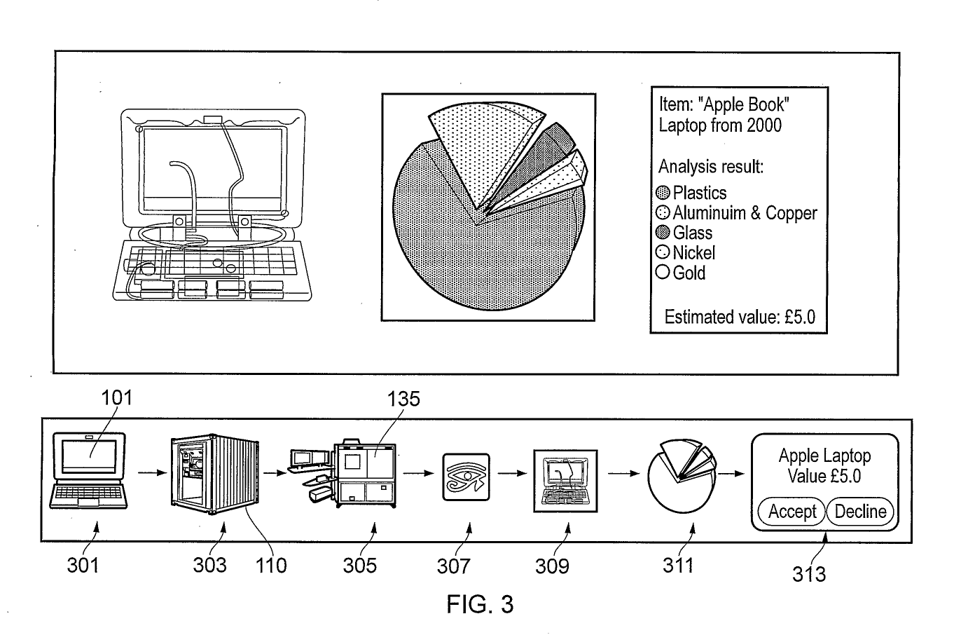

FIG. 3(a) shows an x-ray image of an article obtained using the scanning device 135 of the apparatus. FIG. 3(b) shows a compositional analysis of the article from which relative amounts of different precious materials may be determined. Based on the identity of the article (in this case a laptop computer) and the compositional analysis, a value of the article may be determined.

It is to be understood that because the apparatus is arranged to determine the actual composition of the article submitted, the system is robust against fraudulent use.

Thus, in the event a user submits an empty laptop computer case, having one or more internal components removed, the apparatus 100 would automatically provide a valuation of the article with the one or more components removed, since the composition of the article has been determined by quantitative analysis of the actual materials present at the time of the inspection.

FIG. 3(c) shows a sequence of steps in a valuation according to an embodiment of the invention.

At step 301 the user brings an article (in this case the laptop computer) to the apparatus 100. At step 303 the user submits the article to the apparatus 100 for valuation.

At step 305 the apparatus performs an analysis of the article using the TEDDI materials characterisation technique and at step 307 a computer software program processes the data. (It is to be understood that steps 305 and 307 may be part of a single step).

At step 309 the apparatus displays an image of the article to the user.

At step 311 the apparatus generates an analysis report and at step 313 the apparatus provides a quotation to the user of the price the operator is willing to pay for that article.

In some alternative embodiments no report and/or no image is generated. Rather, the apparatus proceeds directly to present the user with the valuation following completion of the valuation.

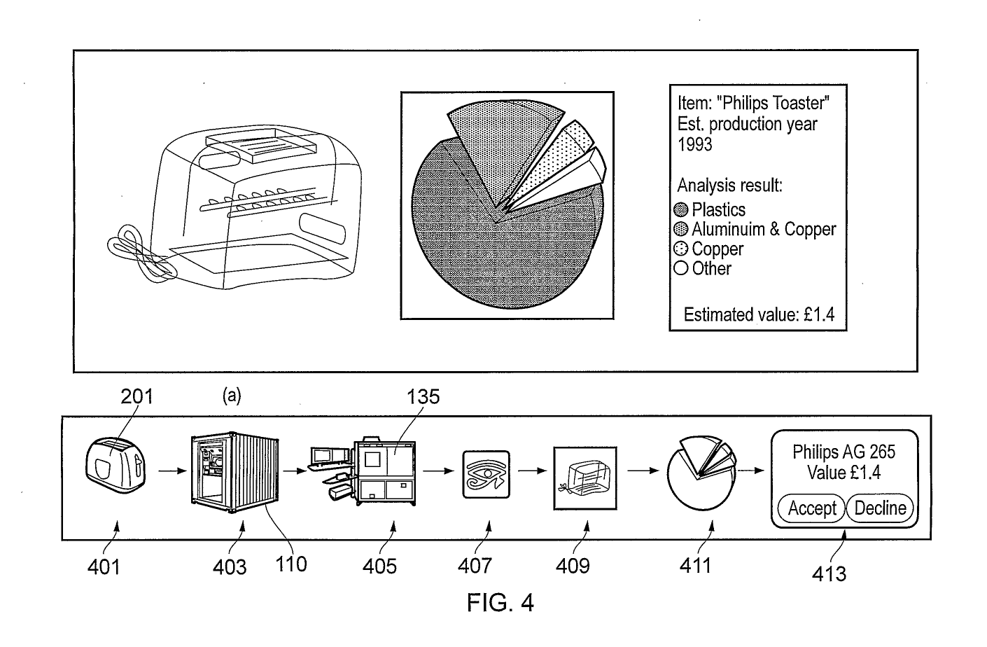

FIG. 4 corresponds to FIG. 3 in respect of a toaster machine 201 rather than a laptop computer. Thus, an x-ray image of the toaster machine is generated by the scanning device as shown in FIG. 4(a) and a compositional analysis performed the results of which are shown in FIG. 4(b).

FIG. 4(c) shows a sequence of steps corresponding to those of FIG. 3(c) and reference numerals used in FIG. 4(c) correspond to those of FIG. 3(c) prefixed with numeral 4 rather than numeral 3.

It is to be understood that in some embodiments a user may be charged for use of the apparatus 100. This is because in some circumstances the valuation service may be a useful service in its own right. For example, the service may be useful to a user in negotiations regarding sale of the article to a third party.

It is to be understood that some embodiments of the invention may be arranged to receive large articles such as monitors, computers, circuit boards etc. Some alternative embodiments may be arranged to receive only smaller articles such as articles of jewellery. Thus, the respective embodiments may be optimised in accordance with an expected size of articles to be valued. Thus, embodiments of the invention intended to value relatively small articles may have a greater precision of analysis than apparatus intended to value much larger items. In some embodiments apparatus is arranged to be optimised for analysis of a given material or prescribed selection of materials. Thus, some embodiments may be arranged to detect precious metals only, or precious and semi-precious metals only. Other arrangements are also useful.

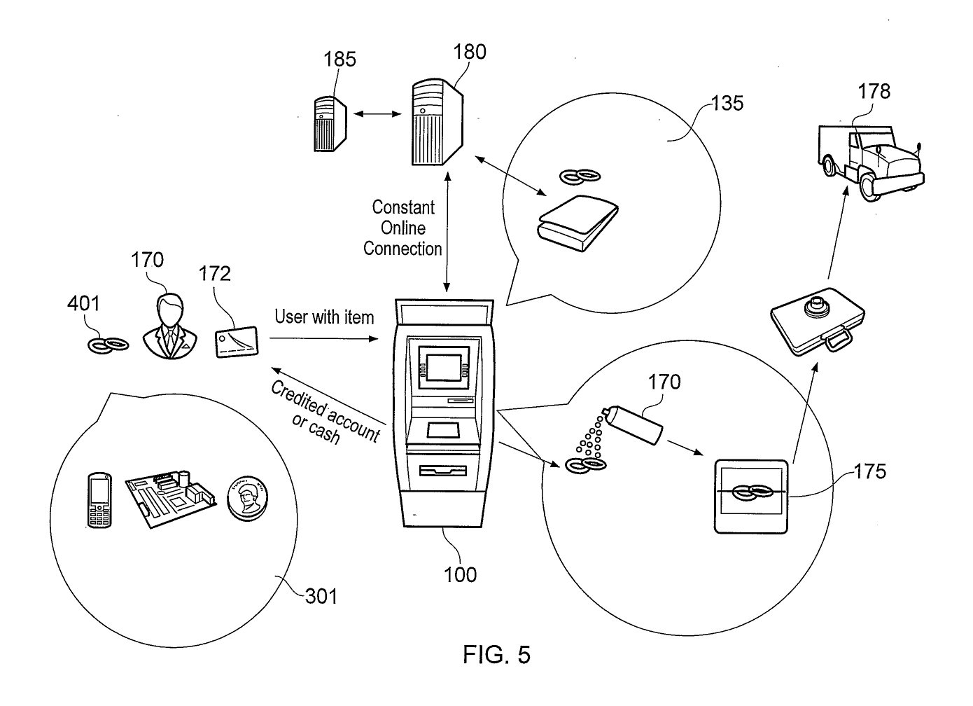

FIG. 5 illustrates a process by which articles are submitted to the apparatus 100, payment made and items removed from the apparatus 100.

As shown, a user 170 may submit a credit or debit card 172 to the apparatus 100 to identify him or herself. An article 401 such as a gold ring may then be submitted for analysis.

If the user chooses to allow the apparatus 100 to keep the article 401 in return for payment, the article 401 may be tagged by the apparatus 100 with an identifying substance by a spray coating device 170 before being placed in a sealed bag 175 ready for collection by security personnel 178 or other operatives.

It is to be understood that other articles 301 such as mobile phones, circuit boards, gold coins or any other article having material of value therein may be analysed by apparatus according to some embodiments of the invention.

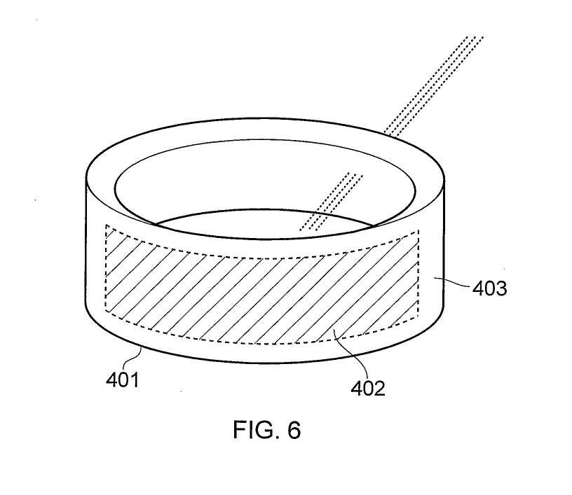

FIG. 6 shows an example of an article that a user might intend to pass off as a solid gold article. The article is a ring 401 having an annular core 402 formed from lead, and a gold coating 403 over the lead core 402. It is to be understood that the value of such a ring is typically lower than a corresponding ring formed entirely from gold since lead has a lower market value than gold. However, an outward appearance of the ring may be indistinguishable from a solid gold ring.

It is to be understood that embodiments of the present invention are able to distinguish between the article shown in FIG. 6 being a ring having a lead core and a similar article having a solid gold core by determining whether any material other than gold is present, and in what amount. Thus, an attempt to pass off the article of FIG. 6 as solid gold would fail.

In some embodiments of the invention arranged to determine the value of gold and not of lead, the apparatus may provide a valuation of the article based on the amount of gold only, and not including the volume of lead. In some embodiments arranged to determine the value of gold and also of lead, the apparatus may provide a valuation of the article based on the amount of gold and the amount of lead.

The apparatus may also adjust the price it is willing to pay for the article based on an ease with which the different materials (here gold and lead) may be separated.

It is to be understood that the invention is not intended to be restricted to the details of the embodiments described above which are described by way of example only.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus for automatic valuation of articles comprising:
an article receiving device arranged to receive an article therein; and
an article assessment device arranged to determine the presence of a prescribed one or more materials in said article along with the quantity thereof,
the article assessment device being arranged to determine a value of the one or more materials present in the article based on a stored amount of the value of a given quantity of each of said one or more materials, and the quantity of the one or more materials present in the article as determined by the article assessment device, and to output to the user the value of said article based on the value of the one or more materials and/or output to the user the value of the one or more materials.

2. Apparatus as claimed in claim 1 wherein the apparatus is operable by a user to do one selected from amongst provide payment to the user in return for the article and to return the article to the user.

3. Apparatus as claimed in claim 1 comprising a dispenser by means of which, if payment is requested by the user, monies or other credit voucher can be issued to the user.

4. Apparatus as claimed in claim 1 arranged to provide a credit to a bank account or credit card account in the event a user requests payment.

5. Apparatus as claimed in claim 1 arranged to perform a tomographic energy dispersive diffraction imaging analysis of the article thereby to determine the amount of a given material in the article.

6. Apparatus as claimed in claim 1 arranged to determine a type of an article presented to the apparatus.

7. Apparatus as claimed in claim 6 arranged to determine a type of the article based on one selected from amongst an input from a user, an output from the article assessment device and an output from an image capture device.

8. Apparatus as claimed in claim 6 arranged to adjust a value of the article or of the one or more materials present in the article based on a cost of extraction of the one or more materials from the article based on the type of article presented.

9. Apparatus as claimed in claim 1 arranged to offer a data recovery service to a user in the event an article having recoverable data therein is presented to the apparatus.

10. Apparatus as claimed in claim 1 arranged to tag an article presented to the apparatus thereby to enable identification of the article as a previously presented article if the article is subsequently presented again to the apparatus.

11. Apparatus as claimed in claim 10 wherein the apparatus is arranged to tag the article after a user consents to the article being retained by the apparatus.

12. Apparatus as claimed in claim 10 wherein the apparatus is arranged to tag the article by application to the article of a quantity of a substance recognisable by the apparatus.

13. Apparatus as claimed in claim 12 wherein the substance comprises a liquid, the apparatus being arranged to apply the liquid to the article by spraying.

14. Apparatus as claimed in claim 1 arranged to convey an article from the article assessment device to a storage portion.

15. Apparatus as claimed in claim 1 arranged to determine the quantity in an article of at least one material selected from amongst a precious metal, a semi-precious metal, a metallic material and a plastics material.

16. Apparatus as claimed in claim 1 arranged to obtain updated market values of the one or more materials in real time.

17. A method of valuing an article comprising:
receiving by means of a receiving device an article to be valued;
determining by means of an article assessment device the presence of a prescribed one or more materials in said article along with the quantity thereof;
determining a value of the one or more materials present in the article based on a stored amount of the value of a given quantity of each of said one or more materials; and
outputting the value of said article based on the value of the one or more materials and/or outputting the value of the one or more materials.

18. A method as claimed in claim 17 comprising the step of offering a user payment in exchange for the article.

19. A method as claimed in claim 18 comprising the step of returning the article to the user if the user rejects the offer of payment.

20. A method as claimed in claim 18 comprising the step of storing the article in the apparatus if the user accepts the offer of payment.

21. A method as claimed in claim 18 comprising the step of dispensing payment to the user by means of a dispenser.

22. A method as claimed in claim 20 comprising the step of issuing credit to a user electronically.

23. A method as claimed in claim 17 wherein the article assessment device is arranged to perform a tomographic energy dispersive diffraction imaging analysis of the article thereby to determine the amount of a given material in the article.

24. A method as claimed in claim 17 comprising the step of identifying a type of the article.

25. A method as claimed in claim 24 wherein the step of identifying the article comprises at least one step selected from amongst the steps of requesting a user to input an indication of the identity of the article, processing data obtained by means of the article assessment device thereby to identify the article and processing data obtained by means of an image capture device thereby to identify the article.

26. A method as claimed in claim 17 comprising the step of adjusting a value of the article based on a cost of extraction of the one or more materials from the article.

27. A method as claimed in claim 17 comprising the step of offering a data recovery service to a user in the event an article potentially having recoverable data therein is presented to the apparatus, the method further comprising recovering data from the article and providing it to the user if the user requests the service.

28. A method as claimed in claim 17 comprising the step of tagging an article introduced into the apparatus thereby to enable identification of the article as a previously introduced article if the article is subsequently reintroduced into the apparatus.

29. A method as claimed in claim 28 comprising the step of tagging the article after a user consents to the article being retained by the apparatus.

30. A method as claimed in claim 28 comprising the step of tagging the article by application to the article of a substance recognisable by the apparatus.

31. A method as claimed in claim 30 wherein the substance comprises a liquid and the method comprises the step of applying the liquid to the article by spraying.

32. A method as claimed in claim 17 comprising the step of determining the quantity of at least one selected from amongst a precious metal, a semi-precious metal, a metallic material and a plastics material contained in the article by means of the article assessment device.

33. A method as claimed in claim 17 comprising the step of updating the amount of the stored value of the given quantity of material based on a current market value of the material.

34-35. (canceled)
